(19) United States
(12) Patent Application Publication
(10) Pub. No.: US 2005/0048347 A1
(43) Pub. Date: Mar. 3, 2005

(54) Separator for fuel cell, end plate for fuel cell, and fuel cell power generation apparatus

(76) Inventors: Masahiro Takashita, Yokohama-shi (JP); Yoshihiko Nakano, Yokohama-shi (JP); Shinetsu Fujieda, Kawasaki-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/879,213

(22) Filed: Jun. 30, 2004

(30) Foreign Application Priority Data
Jul. 2, 2003 (JP) 2003-190340

(51) Int. Cl. H01M 8/02; H01B 1/24

(52) U.S. Cl. 429/34; 252/511

(57) ABSTRACT

The present invention provides a separator for fuel cell, containing an inorganic filler and a thermosetting resin, and having glass transition temperature of 20° C. or less and 100° C. or more, coefficient of thermal expansion at 20° C. of 0.4×10⁻⁵/° C. or more and 4×10⁻⁵/° C. or less, and bending modulus of elasticity at 20° C. of 5 GPa or more and 30 GPa or less.

### CROSS-REFERENCE TO RELATED APPLICATIONS

This application is based upon and claims the benefit of priority from the prior Japanese Patent Application No. 2003-190340, filed Jul. 2, 2003, the entire contents of which are incorporated herein by reference.

### BACKGROUND OF THE INVENTION

1. Field of the Invention

The present invention relates to a separator for fuel cell, an end plate for a fuel cell, and a power generation apparatus comprising a fuel cell.

2. Description of the Related Art

A fuel cell is a generator for converting chemical energy (free energy of combustion reaction) directly into electrical energy. In particular, a liquid fuel cell is a fuel cell for generating electricity by using a liquid fuel such as alcohol, aldehyde, acetic acid, formic acid, and their aqueous solutions, and an oxidizer gas. Since liquid is used as a fuel, it is easier to reduce the size of a system, and it has been intensively studied recently. An example of a liquid fuel cell is a direct methanol fuel cell using an aqueous methanol solution and oxidizer gas for power generation.

A direct methanol fuel cell has a membrane electrode assembly (MEA) having a membrane of a proton conductive electrolyte provided between an anode and a cathode. The proton conductive electrolyte membrane is made of an ion exchange film of perfluorocarbon sulfonic acid, in particular, Nafion (registered trademark) of Dupont. Each electrode comprises a substrate and a catalyst layer, and the catalyst layer includes a catalyst and a resin of a proton conductive electrolyte. The catalyst is generally a noble metal catalyst or its alloy, and is used supported on a catalyst support such as carbon black, or used without being supported. As the catalyst for the anode, Pt—Ru alloy is preferably used, and as the catalyst for the cathode, Pt is preferred. In operation, a aqueous methanol solution is supplied into the anode side, and oxygen gas or air is blown to the cathode side. At this time, at both anode and cathode, reactions shown by Formulas 1 and 2 take place, respectively.
Anode: CH₃OH+H₂O→CO₂+6H⁺+6e⁻ (Formula 1)
Cathode: (3/2)O₂+6H⁺+6e⁻→3H₂O (Formula 2)

That is, by the catalyst in the anode catalyst layer, electrons, protons and carbon dioxide are produced from the methanol and water, and the produced carbon dioxide is released to the atmosphere. Electrons are taken out by an external circuit, and used in power generation. Protons move in the proton conductive electrolyte membrane, and reach the cathode. In the cathode catalyst layer, water is produced by reaction between the electrons, protons and oxygen. The operating temperature of this direct methanol fuel cell is generally 50° C. or more and 120° C. or less.

The MEA and sealing member are enclosed with a separator and end plate, and tightened with tightening screws, so that an embodiment of a direct methanol fuel cell stack is manufactured. On the other hand, a piping is formed in the end plate. A piping and a passage are formed in the separator. Fuel and product are supplied through the passage and piping. The sealing member is used for preventing leak of fuel and product from the piping and passage. Piping may not be formed in the end plate. Usually, the separator is made of carbon, metal, and such materials with a resin or other electric conductive material. The end plate is often made of high-strength metal such as SUS.

When using an electric conductive material as the separator, the location of the MEA is limited. The voltage of the fuel cell is about 0.5 V per unit cell, and is generally low as compared with many other cells. It is therefore attempted to obtain a higher voltage by arranging the MEA in series or parallel, and connecting them electrically in series. However, in the case of a stack formed, for example, by connecting two MEA in parallel, and connecting three such parallel pairs in series, two MEA arranged in parallel must be insulated from each other, and a separator made of an electric conductive material cannot be used.

To solve this problem, Jpn. Pat. Appln. KOKAI Publication No. 4-206162 discloses a separator made of an insulating resin, and a metal mesh as an electric conductive member is embedded in the separator. Other solving means is disclosed in Jpn. Pat. Appln. KOKAI Publication No. 2001-185168, in which an insulating resin plate and a conductive separator are connected to form a flat plate, and a conductor wire is embedded in the insulating resin plate.

However, the separators disclosed in Jpn. Pat. Appln. KOKAI Publication Nos. 4-206162 and 2001-185168 are insufficient in high temperature strength, so that the separators may be bent when the separators are tightened by the end plate, and the fuel flowing in the passage or piping during power generation may leak out from the gap between the sealing member and the separator. Usually, tightening is done at room temperature. On the other hand, the operating temperature of the liquid fuel cell is higher than room temperature as mentioned above. In the separators disclosed in Jpn. Pat. Appln. KOKAI Publication No. 4-206162 and Jpn. Pat. Appln. KOKAI Publication No. 2001-185168, the dimension changes significantly depending on temperature, and even if fuel does not leak at room temperature, the tightening condition may change at operating temperature, and fuel leak may occur.

Besides, when the fuel or product flows in the passage and the load current flows, the separator material may react with the fuel or product, and the separator material is often damaged. In particular, when perfluorocarbon sulfonic acid is contained in an electrolyte membrane, part of the molecule comprised in the electrolyte membrane may elute into the fuel, so that the fuel or product shows a strong acidity, whereby the separator material often corrodes. Hence, the separator material has been demanded to be low in reactivity with the fuel and product, and strong in resistance to corrosion.

Similarly, as with the separator, the end plate is required to be made of a material having a high strength and small in dimensional change due to temperature. When forming a piping in the end plate, too, a material low in reactivity to the fuel and product and strong in resistance to corrosion is needed same as in the separator.

Jpn. Pat. Appln. KOKAI Publication No. 2002-358982 discloses a fuel cell having a structure in which a membrane-electrode assembly (MEA) composed of an anode 2, a cathode 3, and an electrolyte membrane 4 is vertical stacked as shown in FIG. 1 of this publication. In the fuel cell, the surface on which an anode passage 10 of a separator 5 for stack is formed and the surface on which a cathode passage 6 is formed are electrically connected by a conductive region 15, and the area other than this conductive region 15 is formed of an insulating resin region 16.

The separator disclosed in this Jpn. Pat. Appln. KOKAI Publication No. 2002-358982 has the insulating resin region 16 separated by the conductive region 15, and hence the bending strength is lower in the plane direction of the separator. Therefore, when fixing the membrane-electrode assembly and the separator by tightening with screws, the separator may be warped or cracked from the boundary between the conductive region 15 and the insulating resin region 16, thereby forming a gap between the separator and the membrane-electrode assembly. The gas or liquid fuel may leak out from the gap, so that the output voltage may be lowered.

### BRIEF SUMMARY OF THE INVENTION

It is hence an object of the invention to present a separator for fuel cell and an end plate for fuel cell free from distortion such as curving, warping or flexing when tightened by screws, and a fuel cell power generation apparatus comprising such a separator for fuel cell or end plate for fuel cell.

According to a first aspect of the present invention, there is provided a fuel cell power generation apparatus comprising:
a stack section including an anode, a cathode, an electrolyte layer provided between the anode and the cathode, and a separator having at least one of an anode passage which supplies liquid fuel to the anode and a cathode passage which supplies oxidizer to the cathode; and
an end plate provided on the outermost layer of the stack section,
wherein the separator contains an inorganic filler and a thermosetting resin, and has glass transition temperature of 20° C. or less and 100° C. or more, coefficient of thermal expansion at 20° C. of 0.4×10⁻⁵/° C. or more and 4×10⁻⁵/° C. or less, and bending modulus of elasticity at 20° C. of 5 GPa or more and 30 GPa or less.

According to a second aspect of the present invention, there is provided a fuel cell power generation apparatus comprising:
a stack section including an anode, a cathode, an electrolyte layer provided between the anode and the cathode, and a separator having at least one of an anode passage which supplies liquid fuel to the anode and a cathode passage which supplies oxidizer to the cathode; and
an end plate provided on the outermost layer of the stack section,
wherein the end plate contains an inorganic filler and a thermosetting resin, and has glass transition temperature of 20° C. or less and 100° C. or more, coefficient of thermal expansion at 20° C. of 0.4×10⁻⁵/° C. or more and 4×10⁻⁵/° C. or less, and bending modulus of elasticity at 20° C. of 5 GPa or more and 30 GPa or less.

According to a third aspect of the present invention, there is provided a separator for fuel cell, containing an inorganic filler and a thermosetting resin, and having glass transition temperature of 20° C. or less and 100° C. or more, coefficient of thermal expansion at 20° C. of 0.4×10⁻⁵/° C. or more and 4×10⁻⁵/° C. or less, and bending modulus of elasticity at 20° C. of 5 GPa or more and 30 GPa or less.

According to a fourth aspect of the present invention, there is provided an end plate for fuel cell, containing an inorganic filler and a thermosetting resin, and having glass transition temperature of 20° C. or less and 100° C. or more, coefficient of thermal expansion at 20° C. of 0.4×10⁻⁵/° C. or more and 4×10⁻⁵/° C. or less, and bending modulus of elasticity at 20° C. of 5 GPa or more and 30 GPa or less.

### BRIEF DESCRIPTION OF THE SEVERAL VIEWS OF THE DRAWING

FIG. 1 is a schematic partial sectional view showing a stack structure of a direct methanol fuel cell power generation apparatus according to an embodiment of a fuel cell power generation apparatus of the invention.

FIG. 2 is a schematic view showing a MEA in the stack structure of the direct methanol fuel cell power generation apparatus in FIG. 1.

FIG. 3 is a schematic plan view showing an embodiment of a sealing member in the stack structure of the direct methanol fuel cell power generation apparatus in FIG. 1.

FIG. 4A is a schematic plan view showing a cathode separator in the stack structure of the direct methanol fuel cell power generation apparatus in FIG. 1.

FIG. 4B is a sectional view taken along line IVB-IVB of the cathode separator in FIG. 4A.

FIG. 4C is a sectional view taken along line IVC-IVC of the cathode separator in FIG. 4A.

FIG. 5A is a schematic plan view showing an anode separator in the stack structure of the direct methanol fuel cell power generation apparatus in FIG. 1.

FIG. 5B is a sectional view taken along line VB-VB of the anode separator in FIG. 5A.

FIG. 5C is a sectional view taken along line VC-VC of the anode separator in FIG. 5A.

FIG. 6A is a schematic plan view showing another embodiment of the anode separator in the stack structure of the direct methanol fuel cell power generation apparatus in FIG. 1.

FIG. 6B is a sectional view taken along line VIB-VIB of the anode separator in FIG. 6A.

FIG. 6C is a sectional view taken along line VIC-VIC of the anode separator in FIG. 6A.

FIG. 7A is a schematic plan view showing another embodiment of a separator in the stack structure of the direct methanol fuel cell power generation apparatus in FIG. 1.

FIG. 7B is a sectional view taken along line VIIB-VIIB of the separator in FIG. 7A.

FIG. 8 is a schematic partial sectional view showing a stack structure of a direct methanol fuel cell power generation apparatus according to another embodiment of the fuel cell power generation apparatus of the invention.

FIG. 9 is a schematic plan view showing an embodiment of a lateral sealing member in the stack structure of the direct methanol fuel cell power generation apparatus in FIG. 8.

FIG. 10 is a characteristic diagram showing the relation among voltage, current density, and output density in direct methanol fuel cell power generation apparatus in Example 2 and Comparative example 6.

FIG. 11 is a characteristic diagram showing time course changes of voltage in direct methanol fuel cell power generation apparatus in Examples 12 to 14 and Comparative examples 7 and 8.

FIG. 12 is a characteristic diagram showing the relation between voltage and current density in direct methanol fuel cell power generation apparatus in Examples 21 to 24.

FIG. 13A is a schematic plan view showing a separator of a direct methanol fuel cell power generation apparatus in Example 32.

FIG. 13B is a sectional view taken along line XIIIB-XIIIB of the separator in FIG. 13A.

FIG. 13C is a schematic plan view showing a separator of a direct methanol fuel cell power generation apparatus in Comparative example 15.

FIG. 13D is a sectional view taken along line XIIID-XIIID of the separator in FIG. 13C.

FIG. 14 is a characteristic diagram showing average voltage per unit cell of direct methanol fuel cell power generation apparatus in Example 33 to 45.

### DETAILED DESCRIPTION OF THE INVENTION

First of all, a separator for fuel cell and an end plate for fuel cell according to one embodiment of the invention will be described below.

The separator for fuel cell and end plate for fuel cell respectively contain an inorganic filler and a thermosetting resin, and have glass transition temperature of 20° C. or less and 100° C. or more, coefficient of linear expansion at 20° C. of 0.4×10⁻⁵/° C. or more and 4×10⁻⁵/° C. or less, and bending modulus of elasticity at 20° C. of 5 GPa or more and 30 GPa or less.

The present inventors studied intensively and discovered that the fuel cell power generation apparatus improved in output characteristics can be obtained when the three characteristics of glass transition temperature, coefficient of linear expansion at 20° C., and bending modulus of elasticity at 20° C. satisfy the specified range. And the present inventors discovered that when the three characteristics satisfy the specified range, warping, flexing, folding or other deformation when tightening with screws can be suppressed, and at the same time, the expansion and contraction by temperature changes can be suppressed, while maintaining a high volume resistivity capable of insulating between MEA.

The thermosetting resin includes epoxy resin, maleimide resin, phenol resin, polyester resin, diallyl phthalate resin, silicone resin, etc. One or more types of thermosetting resin components may be used. Raw material components for the thermosetting resin, curing catalyst and others can be properly selected from the viewpoint of thermal expansion, heat resistance, elution of ionic impurities, elution of unreacted components, and water resistance when the thermosetting resin is combined with inorganic fillers.

The inorganic fillers are contained in the separator and end plate for the purpose of decreasing the thermal expansion. Examples of the inorganic fillers include silicon oxide powder such as crystal silica or fused silica, alumina, zirconia, calcium silicate, talc, mica, silicon carbide, silicon nitride, boron nitride, calcium carbonate, glass fiber, carbon fiber, boron fiber, ceramic fiber such as alumina fiber, and varieties of whisker. Further, for the purpose of increasing the strength, inorganic cloth using glass fiber, organic cloth using aramid fiber, and the like may be also used as an inorganic filler. One or more types of inorganic filler components may be used.

In the separator and end plate, the content of the thermosetting resin is preferred to be 1 wt. % or more and 47 wt. % or less. If the content of the thermosetting resin is out of this range, the glass transition temperature, coefficient of linear expansion, and bending modulus of elasticity of the separator and end plate may not satisfy the required range.

In the separator and end plate, when the content of the thermosetting resin is in a range of 1 wt. % or more and 47 wt. % or less, the content of the inorganic filler is preferred to be 50 wt. % or more and 96 wt. % or less. As a result, the strength and insulation of the separator and end plate may be further enhanced.

The operating temperature of a liquid fuel cell is determined depending on the characteristics of the electrolyte membrane or characteristics of the catalyst. Generally, the operating temperature is 20° C. or more and 100° C. or less. The resin changes in its characteristic significantly from the boundary of the glass transition temperature. Accordingly, the glass transition temperature must be 20° C. or less and 100° C. or more.

The lower limit of the glass transition temperature is preferred to be −100° C. If the glass transition temperature is lower than −100° C., the difference between the operating temperature of the fuel cell and the glass transition temperature is too large, and the molecular motion in the resin becomes violent. Therefore, traces of resin may elute into the fuel, which may lead to deterioration of fuel cell performance. The upper limit of the glass transition temperature is preferred to be 250° C. If the glass transition temperature exceeds 250° C., the resin is very stiff and hard to process, and surface treatment described below is also difficult. For this reason, it is not preferred practically.

Since the coefficient of thermal expansion of the thermosetting resin increases along with temperature rise, the coefficient of linear expansion of the separator for liquid fuel cell and end plate for liquid fuel cell is required to be sufficiently small at 100° C. In an ordinary condition of use, the coefficient of linear expansion at 20° C. is preferred to be 4×10⁻⁵/° C. or less, more preferably 1.5×10⁻⁵/° C. or less. If smaller than 0.4×10⁻⁵/° C., by contrast, the separator is likely to be broken at the time of fixing. Practically, it is not required to be set too low. A more preferred range of the coefficient of linear expansion at 20° C. is 0.4×10⁻⁵/° C. to 1×10⁻⁵/° C.

If the bending strength of the separator is small, the separator is likely to be bent at the time of fixing. If the bending strength of the end plate is small, the end plate may deflect at the time of fixing, so that the stack section may not be tightened. If the bending modulus of elasticity at 20° C. is 5 GPa or more, such problems can be solved. It is particularly preferred to be 10 GPa or more. On the other hand, if the bending strength exceeds 30 GPa, the strength is too much and elasticity is lost, whereby the separator and end plate may be likely to be broken at the time of tightening. Such being strength is not needed for solving the problems of the invention. A more preferred range of the bending strength at 20° C. is 15 GPa to 30 GPa.

The separator and end plate are sufficient in insulation if the volume resistivity is 1×10¹⁰ Ωcm or more. Resistivity over 1×10³⁰ Ωcm is not needed for insulation. And, if the volume resistivity exceeds 1×10³⁰ Ωcm, it is required to limit about composition and amount of various parting agents, binder and other materials to be mixed in the manufacturing process, or amount of impurities.

The separator and end plate may be formed of an inorganic filler and a thermosetting resin, respectively, but an electric conductive substance may be further added. When the volume resistivity of the electric conductive portion formed of electric conductive substance is in the range of 0.1 μΩcm or more and 3000 μΩcm or less, it is enough for the purpose of connecting MEA. If higher than this limit, the resistance component increases. To set it lower, it is required to remove impurities and lattice defects in the electric conductive substance excessively, so that it is not preferred practically. From the viewpoint of heightening the bending strength in the in-plane direction in the separator and end plate, the electric conductive portion is preferred to be provided on the surface, or to be formed in a recess of a surface of the separator. The electric conductive portion may be provided either in one surface or in both surfaces.

In one embodiment of the invention, a sealing member including the electric conductive substance can be used. When the amount of electric conductive substance added to the separator increases, the separator manufacturing process is too much complicated, but this problem can be avoided by employing the sealing member. The sealing member may be formed by known art from silicone rubber, fluoroplastics such as polytetrafluoroethylene (PTFE) and perfluoroalkoxy resin (PFA), butadiene rubber, etc. Electric connection portions formed of electric conductive substance may be favorably used as far as the volume resistivity is in a range of 0.1 μΩcm or more and 3000 μΩcm or less.

The separator for fuel cell and end plate for fuel cell according to an embodiment of the invention can be manufactured in various molding methods, including transfer molding, compression molding, lamination molding, injection, and other methods.

In the separator for fuel cell and end plate for fuel cell according to the embodiment of the invention described so far, since the bending strength in the plane direction is strong, warping, flexing, folding or other deformation at the time of tightening with screws can be suppressed. Besides, since the volume resistivity is sufficiently low, it is easy to insulate the MEA arranged in a plane. In addition, since reactivity to the fuel and product is low, and resistance to corrosion is strong, it is ideal for liquid fuel cell.

The separator for fuel cell and end plate for fuel cell according to the embodiment of the invention are very low in water absorption as compared with carbon or the like used as a material for a known separator for liquid fuel cell. If carbon is used as a separator for liquid fuel cell, part of the fuel is absorbed by the separator, and as a result, the fuel utility efficiency of the liquid fuel is lowered. By this material of the invention, the utility efficiency of the liquid fuel can be enhanced.

The separator for fuel cell and end plate for fuel cell provided by the embodiment of the invention can be treated by known surface coating process such as water repellent process, and hydrophilic process depending on the type and flow rate of flowing fuel or product, and can be enhanced in corrosion resistance, or improved in smoothness of flow of aqueous methanol solution, carbon dioxide, air or water flowing in the passage.

The inventors have proved that plasma processing is suited for the purpose of smoothing the flow of liquid in the separator and end plate. The end plate and separator provided by an embodiment of the invention tend to be excessive in water repellent property, and liquid fuel and produced water may be repelled, which may impair the flow of liquid fuel and produced water in the end plate and separator. This tendency is prominent if parting agent is mixed, in particular. This is estimated because water repellent components such as parting agent is maldistributed about on the surface of the separator and end plate.

To avoid this phenomenon, it is preferred to treat at least one of the separator and end plate by polishing process by sand paper, polishing process by glass beads, or plasma process. By these methods, water repellent components scattering about on the surface of the end plate and separator can be removed, and therefore, the wettability of the end plate and separator to the liquid fuel and produced water can be enhanced. In particular, by plasma processing, the surface of the end plate and separator is hardly damaged, so that the fuel and oxidizer are less likely to leak. And, by plasma processing, fluctuations of processing can be suppressed. Methods of plasma processing include reactive ion etching (RIE) method and direct plasma (DP) method. As the gas used for processing, at least one of O₂ gas and Ar gas may be used.

The contact angle of the separator and the contact angle of the end plate are preferred to be in a range of 0 degree to 50 degrees. If the contact angle exceeds 50 degrees, since the contact with liquid fuel and produced water is poor, flow of liquid fuel and produced water is not stabilized, and hence the voltage fluctuation range at constant load current may increase. If the contact angle is less than 10 degrees, absorption reaction of liquid fuel may occur, and the fuel utility efficiency may drop. Accordingly, in the separator and end plate for anode, the contact angle should be set in a range of 10 degrees to 50 degrees more preferably. As the method of defining the contact angle within 0 degree to 50 degrees, other method than the surface treatment method mentioned above may be effective.

Materials provided by one embodiment of the invention may be used very preferably also in other members than the separator and end plate. For example, the materials may be used in piping for flow of liquid fuel or cathode produced water. In the direct methanol fuel cell, in particular, methanol supplied in the anode passes through the electrolyte membrane and reaches up to the cathode, which is known as methanol crossover. Accordingly, methanol is likely to mix into the cathode produced water. Materials provided by the invention sufficiently withstand corrosion of methanol, and therefore not only the piping for flow of liquid fuel but also the piping for collecting the water produced at the cathode may be formed of the materials provided by the invention.

Jpn. Pat. Appln. KOKAI Publication No. 2001-266911 discloses a technology of a sealing member for covering a gas passage, and this sealing member can be formed by the materials of one embodiment of the invention. The technology provided by the invention can be used in both a liquid fuel cell and gas fuel cell.

The fuel cell power generation apparatus according to an embodiment of the invention comprises at least one of a separator according to an embodiment of the invention and an end plate according to an embodiment of the invention. In the fuel cell power generation apparatus according to the embodiment of the invention, either liquid fuel or gas fuel can be used. The liquid fuel includes methanol, ethanol, diethylether, dimethoxy methane, formaldehyde, formic acid, methyl formate, orthomethyl formate, trioxane, 1-propanol, 2-propanol, 3-propanol, ethylene glycol, glyoxal, glycerin, and their aqueous solutions.

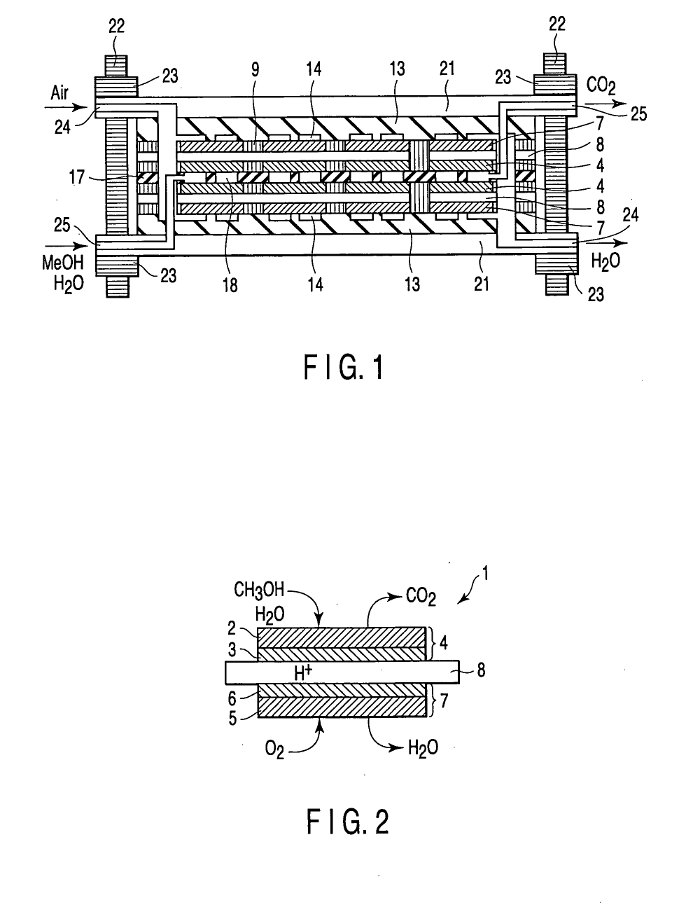

An embodiment of a liquid fuel cell power generation apparatus will be explained by referring to FIGS. 1 to 9.

The liquid fuel cell power generation apparatus shown in FIG. 1 comprises a plurality of MEA 1. Each MEA 1 comprises, as shown in FIG. 2, an anode 4 having an anode catalyst layer 3 formed on an anode substrate 2, a cathode 7 having a cathode catalyst layer 6 formed on a cathode substrate 5, and a proton conductive electrolyte membrane 8 arranged between the anode catalyst layer 3 and the cathode catalyst layer 6. In this apparatus, 16 sets of MEA 1 are connected in parallel, and two rows of such MEA are stacked up.

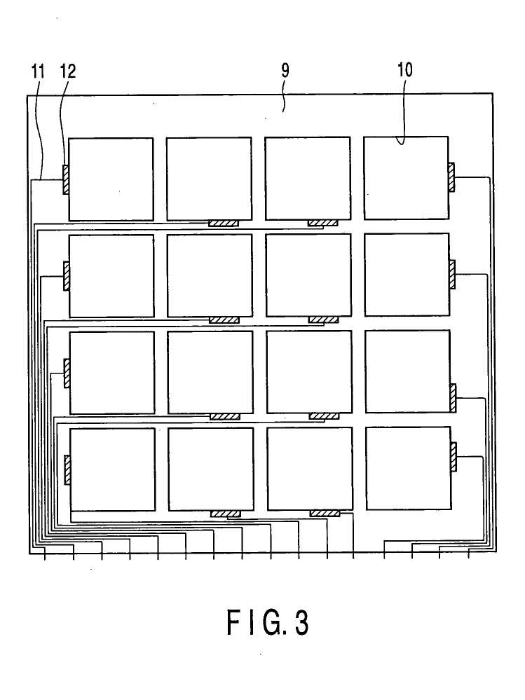

As shown in FIG. 3, a sealing member 9 has 16 square holes 10 for inserting electrodes, and comprises conductor wires 11 and electric conductive portions 12. The electric conductive portion 12 contacts electrically with the electric conductive portion of the separator described later. Load current picked up from the MEA is taken outside of the separator by way of the conductor wire 11. All known electric conductive materials can be used for the electric conductive portion 12. For example, gold, metals other than gold, carbon, and mixed material of carbon and resin can be used. However, when Nafion of strong acidity is used as a material of the electrolyte membrane, it is preferred to use an acid-fast material. Metals other than gold include, for example, special use stainless steel (SUS), silver, platinum, ruthenium, rhodium, palladium, rhenium, osmium, iridium, or their alloys.

The sealing member 9 is arranged such that anodes 4 are inserted into the square holes 10 at one surface of the proton conductive electrolyte membrane 8, and cathodes 7 are inserted into the square holes 10 at the other surface of the proton conductive electrolyte membrane 8. Therefore, the periphery of the MEA 1 can be surrounded, and fuel leak from the MEA 1 can be prevented.

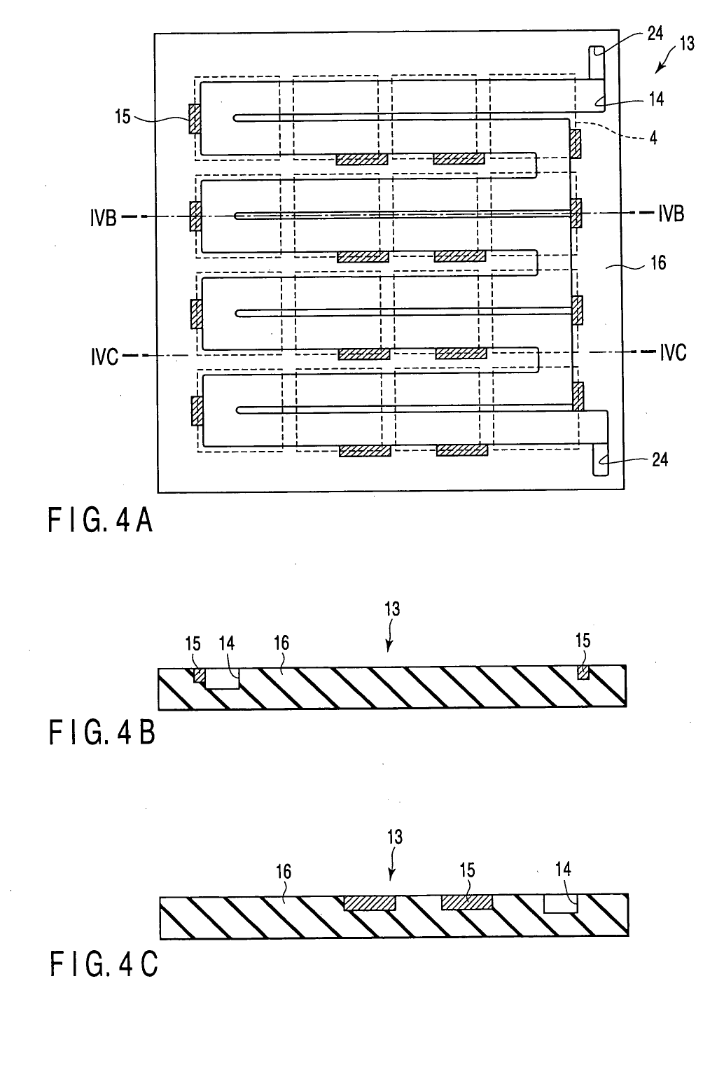

FIG. 4A is a schematic plan view of a cathode separator in the stack structure of the direct methanol fuel cell power generating apparatus in FIG. 1. FIG. 4B is a sectional view taken along line IVB-IVB of the cathode separator in FIG. 4A, and FIG. 4C is a sectional view taken along line IVC-IVC of the cathode separator in FIG. 4A. The cathode separator 13 has, for example, a serpentine cathode passage 14. The area indicated by dotted line is the section for installing the cathode 7. The shape of the passage is not particularly specified. An electric conductive portion 15 is formed as a terminal for electrically connecting each MEA. The electric conductive portion 15 is formed in the groove of the surface of the cathode separator 13. Other positions than the electric conductive portions 15 are insulating regions 16 including a thermosetting resin and an inorganic filler. This cathode separator 13 is arranged in the cathode 7 of each MEA such that the electric conductive portions 15 is connected to the electric conductive portions 12 of the sealing member 9.

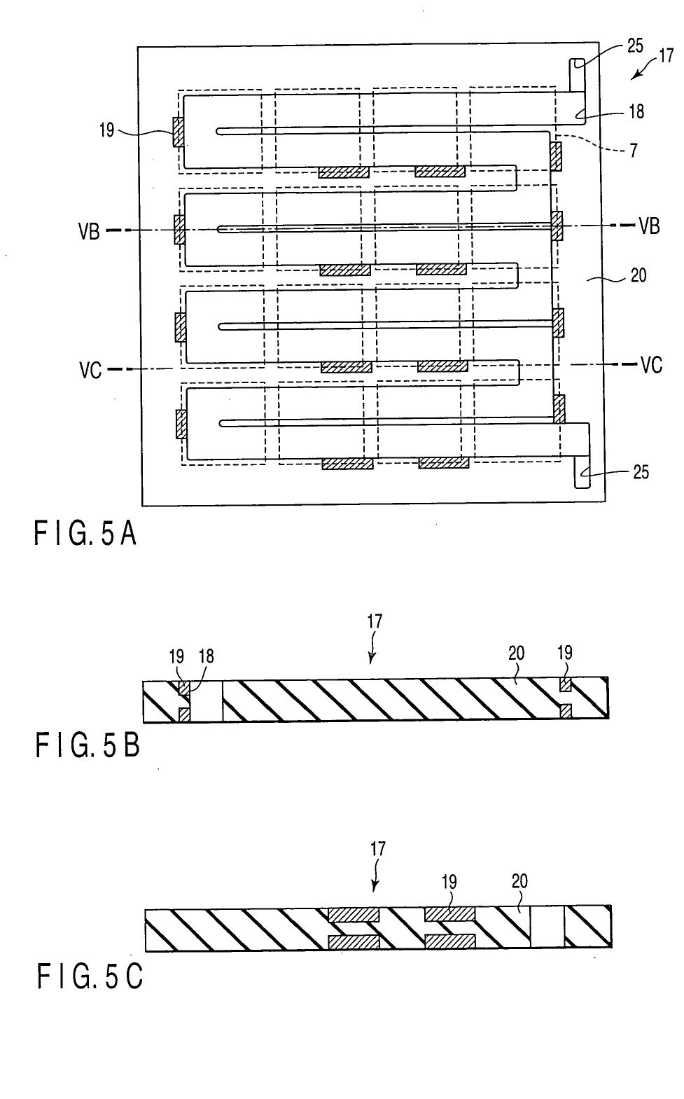

On the other hand, FIG. 5A is a schematic plan view of an anode separator in the stack structure of the direct methanol fuel cell power generating apparatus in FIG. 1. FIG. 5B is a sectional view taken along line VB-VB of the anode separator in FIG. 5A, and FIG. 5C is a sectional view taken along line VC-VC of the anode separator in FIG. 5A. The anode separator 17 has, for example, a serpentine anode passage 18. The area indicated by dotted line is the section for installing the anode 4. The shape of the passage is not particularly specified. An electric conductive portion 19 is formed as a terminal for electrically connecting each MEA. The electric conductive portion 19 is formed in the groove of both surfaces of the anode separator 17. Other positions than the electric conductive portions 19 are insulating regions 20 including a thermosetting resin and an inorganic filler. This anode separator 17 is arranged between one MEA section consisting of 16 sets of MEA and the other MEA section consisting of 16 sets of MEA. The electric conductive portions 190 of the anode separator 17 is connected to the electric conductive portions 12 of the sealing member 9. Same effects are obtained if the shapes of the anode separator and cathode separator are exchanged. Of course, the anode separator and cathode separator may be formed in the same shape. For example, the structure shown in FIGS. 4A to 4C may be applied in both the anode separator and cathode separator.

In the cathode separator and anode separator, all known electric conductive materials can be used for the electric conductive portions. Usable materials include, for example, carbon; metals such as SUS, gold, silver, platinum, ruthenium, rhodium, palladium, rhenium, osmium, iridium, or their alloys; mixed materials of carbon and resin; and the like. However, when Nafion of strong acidity is used as a material of the electrolyte membrane, it is preferred to use an acid-fast material. Besides, considering the environments likely to induce electrochemical reaction, it is preferred to use materials resisting such reaction. In this respect, for example, it is preferred to use platinum, titanium plated with platinum, carbon, or mixed material of carbon and resin. The shape of the electric conductive portion is not limited to the box shape as shown in the figure. What is particularly preferred when fabricating the separator by insert molding is a technique of molding an electric conductive portion having a convex section by pressing the pointed convex part to the separator surface.

An end plate 21 is arranged on the outermost layer of the stack section including the MEA 1, sealing member 9, cathode separator 13 and anode separator 17, in this case, on the cathode separator 13. The stack section is tightened with tightening bolts 22 and tightening nuts 23. A tightening method may be realized by any known method. For example, as disclosed in Jpn. Pat. Appln. KOKAI Publication No. 09-92324, without using the tightening bolts 22 and tightening nuts 23, it can be preferably tightened by using a clip-like object.

As fuel, aqueous methanol solution is introduced from an anode manifold 25 into the anode passage 18, and supplied into the anode 4. On the other hand, as oxidizer gas, air or oxygen or their mixture is introduced from a cathode manifold 24 into the cathode passage 14, and supplied into the cathode 7.

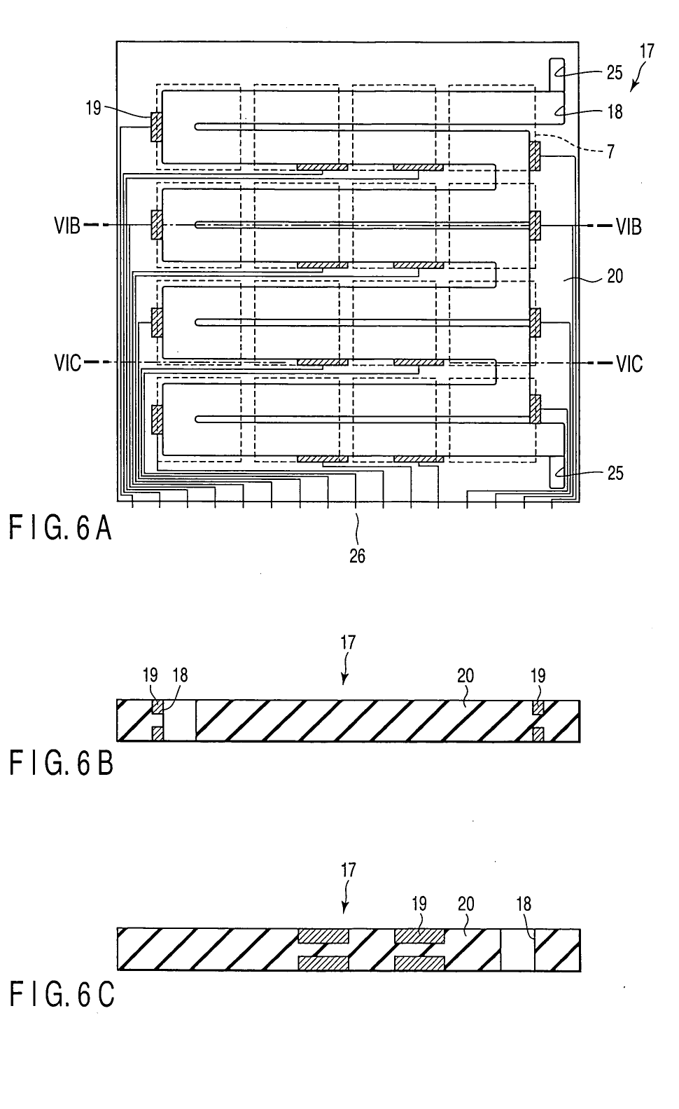

In the foregoing FIGS. 1 to 5, the conductor wire 11 is formed on the sealing member 9, but instead of forming on the sealing member 9, as shown in FIGS. 6A to 6C, a conductor wire 26 may be embedded in the anode separator 17. In the cathode separator 13, too, a conductor may be similarly embedded.

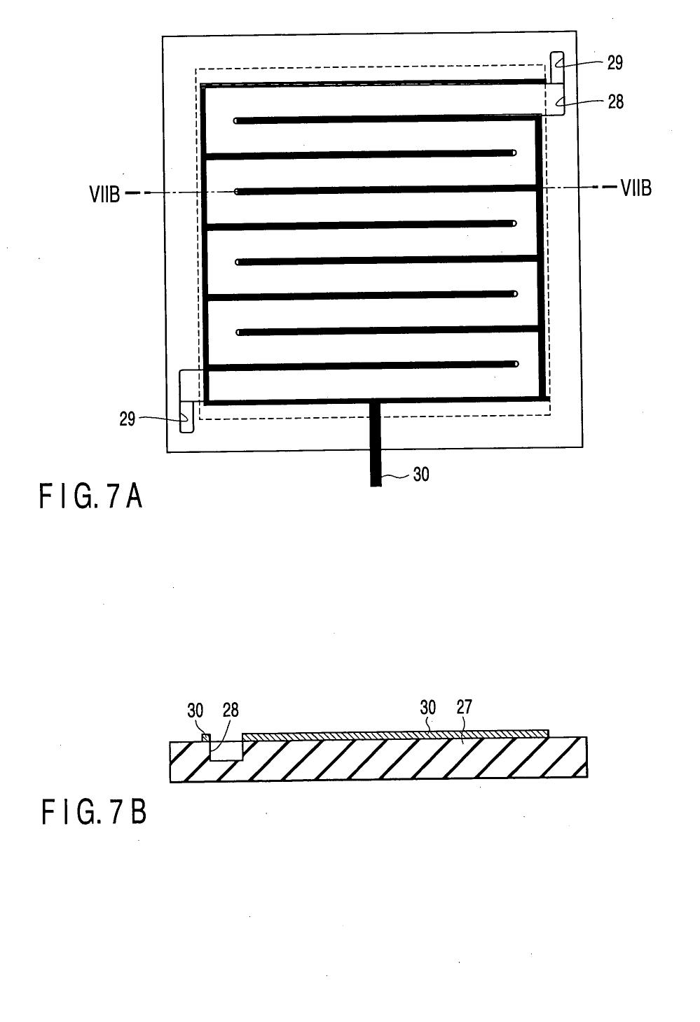

In the foregoing FIGS. 1 to 5, the electric conductive portions are provided in the grooves of the surface of the separator, but instead of forming he electric conductive portions, the electric conductivity may be achieved by arranging an electric conductive sheet on the separator. This example is shown in FIG. 7. FIG. 7A is a schematic plan view showing another embodiment of a separator in the stack structure of the direct methanol fuel cell power generating apparatus in FIG. 1. FIG. 7B is a sectional view taken along line VIIB-VIIB of the separator in FIG. 7A. In a separator 27 made of insulating material including a thermosetting resin and an inorganic filler, a passage 28 is formed, which functions as an anode passage or cathode passage. Both ends 29 of the passage 28 function as an anode manifold or cathode manifold. An electric conductive sheet 30 is arranged on the surface of the separator 27.

Materials for forming the electric conductive sheet include, for example, gold, silver, copper, titanium, chromium, manganese, iron, cobalt, nickel, zinc, niobium, yttrium, zirconium, molybdenum, ruthenium, rhodium, palladium, cadmium, hafnium, tantalum, tungsten, rhenium, osmium, iridium, platinum, lanthanum, cerium, praseodymium, neodymium, samarium, europium, gadolinium, terbium, dysprosium, holmium, erbium, thulium, ytterbium, lutetium, their plated metals, carbon and other electric conductive material. To avoid corrosion, more preferred materials include carbon, mixture of carbon and resin, gold, silver, ruthenium, rhodium, palladium, or platinum, or include other metal materials by coating with these materials by plating or the like.

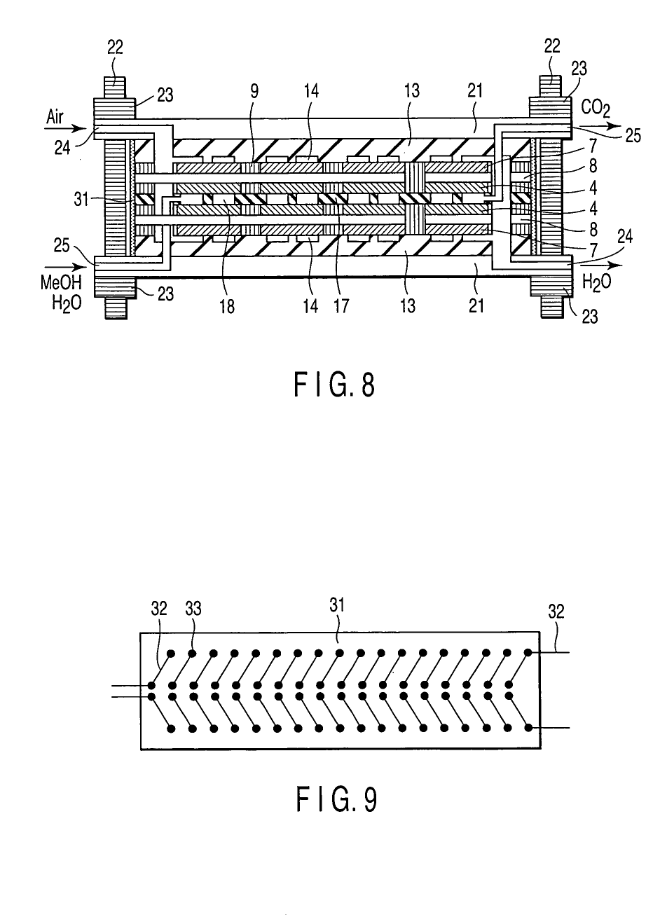

In FIG. 1, the sealing member is provided between the electrodes, but as shown in FIGS. 8 and 9, a lateral sealing member 31 may be provided at the side of the stack section. In FIGS. 8 and 9, same members as explained in FIG. 1 are identified with same reference numerals, and description is omitted.

FIG. 9 is a plan view of a lateral sealing member. The lateral sealing member 31 includes conductor wires 32 and electric conductive portions 33. By providing the lateral sealing member 31 at the side of the stack section, evaporation of aqueous methanol solution from the electrolyte membrane side can be prevented, and the MEA can be connected in series electrically.

Examples of the invention will be described below while referring to the accompanying drawings.

Resins A to T in the composition shown in Tables 1 and 2 were prepared. That is, after mixing the thermosetting resin, hardener, hardening accelerator, inorganic filler, parting agent, pigment, flame retardant aid, and silane coupling agent shown in Table 3 at the amount prescribed in Tables 1 and 2, they were uniformly mixed in Henschel mixer. By mixing uniformly using two rolls, the materials were ground, and formed into resin tablets of desired shape.

TABLE 1

| | | | | Inorganic filler | | | | Flame | Silane |
|---|---|---|---|---|---|---|---|---|---|
| | | | Hardening | | Blending | Parting | | retardant | coupling |
| | Thermosetting | Hardener | accelerator | | ratio | agent | Pigment | aid | agent |
| | resin | (wt. %) | (wt. %) | Type | (wt. %) | (wt. %) | (wt. %) | (wt. %) | (wt. %) |
| Resin A | Epoxy A; 55.5 wt. % | 32.3 | 0.2 | Not | 0 | 0.4 | 0.3 | 2 | 0.3 |
| | Epoxy B; 9 wt. % | | | added | | | | | |
| Resin B | Epoxy A; 32.6 wt. % | 19 | 0.1 | Silica | 40 | 0.4 | 0.3 | 2 | 0.3 |
| | Epoxy B; 5.3 wt. % | | | | | | | | |
| Resin C | Epoxy A; 29.7 wt. % | 17.4 | 0.1 | Silica | 45 | 0.4 | 0.3 | 2 | 0.3 |
| | Epoxy B; 4.8 wt. % | | | | | | | | |
| Resin D | Epoxy A; 26.8 wt. % | 15.7 | 0.1 | Silica | 50 | 0.4 | 0.3 | 2 | 0.3 |
| | Epoxy B; 4.4 wt. % | | | | | | | | |
| Resin E | Epoxy A; 21.1 wt. % | 12.4 | 0.1 | Silica | 60 | 0.4 | 0.3 | 2 | 0.3 |
| | Epoxy B; 3.4 wt. % | | | | | | | | |
| Resin F | Epoxy A; 15.4 wt. % | 9 | 0.1 | Silica | 70 | 0.4 | 0.3 | 2 | 0.3 |
| | Epoxy B; 2.5 wt. % | | | | | | | | |
| Resin G | Epoxy A; 9.7 wt. % | 5.6 | 0.1 | Silica | 80 | 0.4 | 0.3 | 2 | 0.3 |
| | Epoxy B; 1.6 wt. % | | | | | | | | |
| Resin H | Epoxy A; 4 wt. % | 2.3 | 0.1 | Silica | 90 | 0.4 | 0.3 | 2 | 0.3 |
| | Epoxy B; 0.6 wt. % | | | | | | | | |
| Resin I | Epoxy A; 0.5 wt. % | 0.3 | 0.1 | Silica | 96 | 0.4 | 0.3 | 2 | 0.3 |
| | Epoxy B; 0.1 wt. % | | | | | | | | |
| Resin J | Epoxy A; 15.4 wt. % | 9 | 0.1 | Zirconia | 70 | 0.4 | 0.3 | 2 | 0.3 |
| | Epoxy B; 2.5 wt. % | | | | | | | | |

TABLE 2

| | | | | Inorganic filler | | | | | Silane |
|---|---|---|---|---|---|---|---|---|---|
| | | | Hardening | | Blending | Parting | | Flame | coupling |
| | | Hardener | accelerator | | ratio | agent | Pigment | retardant | agent |
| | Thermosetting resin | (wt. %) | (wt. %) | Type | (wt. %) | (wt. %) | (wt. %) | aid (wt. %) | (wt. %) |
| Resin K | Epoxy A; 15.4 wt. % | 9 | 0.1 | Alumina | 70 | 0.4 | 0.3 | 2 | 0.3 |
| | Epoxy B; 2.5 wt. % | | | | | | | | |
| Resin L | Epoxy A; 15.4 wt. % | 9 | 0.1 | Titania | 70 | 0.4 | 0.3 | 2 | 0.3 |
| | Epoxy B; 2.5 wt. % | | | | | | | | |
| Resin M | Maleimide; 29 wt. % | 0 | 0 | Silica | 70 | 0.4 | 0.3 | 0 | 0.3 |
| Resin N | Phenol; 29 wt. % | 0 | 0 | Silica | 70 | 0.4 | 0.3 | 0 | 0.3 |
| Resin O | Polyester; 29 wt. % | 0 | 0 | Silica | 70 | 0.4 | 0.3 | 0 | 0.3 |
| Resin P | Diallyl phthalate; | 0 | 0 | Silica | 70 | 0.4 | 0.3 | 0 | 0.3 |
| | 29 wt. % | | | | | | | | |
| Resin Q | Silicone; 29 wt. % | 0 | 0 | Silica | 70 | 0.4 | 0.3 | 0 | 0.3 |
| Resin R | Silicone; 39 wt. % | 0 | 0 | Silica | 60 | 0.4 | 0.3 | 0 | 0.3 |
| Resin S | Silicone; 49 wt. % | 0 | 0 | Silica | 50 | 0.4 | 0.3 | 0 | 0.3 |
| Resin T | Silicone; 59 wt. % | 0 | 0 | Silica | 40 | 0.4 | 0.3 | 0 | 0.3 |

TABLE 3

| Type of resin | | |
|---|---|---|
| Thermosetting | Epoxy resin A | Cresol novolak epoxy resin (Sumitomo Chemical Co., Lt.) |
| resin | Epoxy resin B | Flame retardant epoxy resin (Nihon Kayaku Co., Ltd.) |
| | Maleimide resin | 4-4′ diphenyl methane bismaleimide (KI Chemical Industry |
| | | Co., Ltd.) |
| | Phenol resin | Thermosetting phenol resin (Meiwa Chemical Co., Ltd.) |
| | Polyester resin | Unsaturated polyester resin Polyset (Hitachi Chemical Co., |
| | | Ltd.) |
| | Diallyl phthalate | Diallyl phthalate resin (Daiso Co., Ltd.) |
| | resin | |
| | Silicone resin | Addition type liquid silicone rubber TSE3431 (GE Toshiba |
| | | Silicones) |

| | |
|---|---|
| Hardener | Phenol novolak resin |
| Hardening accelerator | Imidazole (Shikoku Kasei Corporation) |
| Inorganic filler | Silica (granular, average particle size 1 μm) |
| | Zirconia (granular, average particle size 1 μm) |
| | Alumina (granular, average particle size 1 μm) |
| | Titania |
| Parting agent | Carnauba wax (Nihon Fine) |
| Pigment | Carbon black (Mitsubishi Chemical Co., Ltd.) |
| Flame retardant aid | Antimony trioxide |
| Silane coupling agent | Silane coupling agent |

### EXAMPLES 1 AND 2, AND COMPARATIVE EXAMPLES 1 TO 6

Resin tablets A, B, D, E in Tables 1 and 2 were processed into the shapes shown in FIGS. 7A and 7B by using a transfer molding machine. Commercial products of peak polyether ether ketone (PEEK), polyether imide (PEI), polyether sulfone (PES), and polyphenylene sulfide (PPS) were prepared. PEEK, PEI and PPS is a commercial product of Nippon Polypenco Limited, respectively. PES is a commercial product of Sumito Chemical Co., Ltd. PEEK, PEI, PES and PPS were processed into the shapes shown in FIGS. 7A and 7B by machining. As a result, separators having an electrode area of 25 cm² in Examples 1 and 2 and Comparative examples 1 to 6 were obtained. The thickness of the separator was 3 mm. A gold foil was arranged on the separator surface. The electrical resistivity of gold was 2 μΩcm.

Properties of the separators were measured in the following methods, and results are shown in Table 4.

The bending strength of the separator at 20° C. was measured according to JIS K 6911. The coefficient of linear expansion at 20° C. and the glass transition point were measured by using TMA apparatus of Seiko Electronics as a thermal and mechanical characteristic analyzer. The electrical resistivity was measured by using a four-terminal method.

Two separators made of the same material were used as an anode separator and a cathode separator, and a single cell was fabricated in the following method.

(Fabrication of MEA)

By a known method (R. Ramakumar et al., J. Power Sources 69 (1997) 75), catalyst (Pt:Ru=1:1) carrier carbon black for anode, and catalyst (Pt) carrier carbon black for cathode were prepared. The carbon black was a commercial product of Printex 25 carbon black of Degussa. The catalyst carrying amount was 30 for anode and 15 for cathode by ratio by weight to 100 of carbon.

(Anode)

In the catalyst carrier carbon black for anode prepared in the above process, perfluorocarbon sulfonic acid solution (Nafion solution SE-20092 of Dupont), deionized water, and alcohol were added, the catalyst carrier carbon black was dispersed, and a catalyst layer paste was prepared. This paste was applied on a carbon paper (TGPH-120 of E-TEK) treated by water repellent process, and dried, and an anode was obtained.

(Cathode)

In the catalyst carrier carbon black for cathode prepared in the above process, perfluorocarbon sulfonic acid solution (Nafion solution SE-20092 of Dupont) and deionized water were added, the catalyst carrier carbon black was dispersed, and a catalyst layer paste was prepared. This paste was applied on a carbon paper (TGPH-090 of E-TEK) treated by water repellent process, and dried, and a cathode was obtained.

Using a commercial perfluorocarbon sulfonic acid film (Nafion 117 of Dupont) as a proton conductive electrolyte membrane, the anode and cathode were bonded on both surfaces by hot press (125° C., 5 minutes), and an MEA with an electrode area of 25 cm² (5 cm by 5 cm) was fabricated.

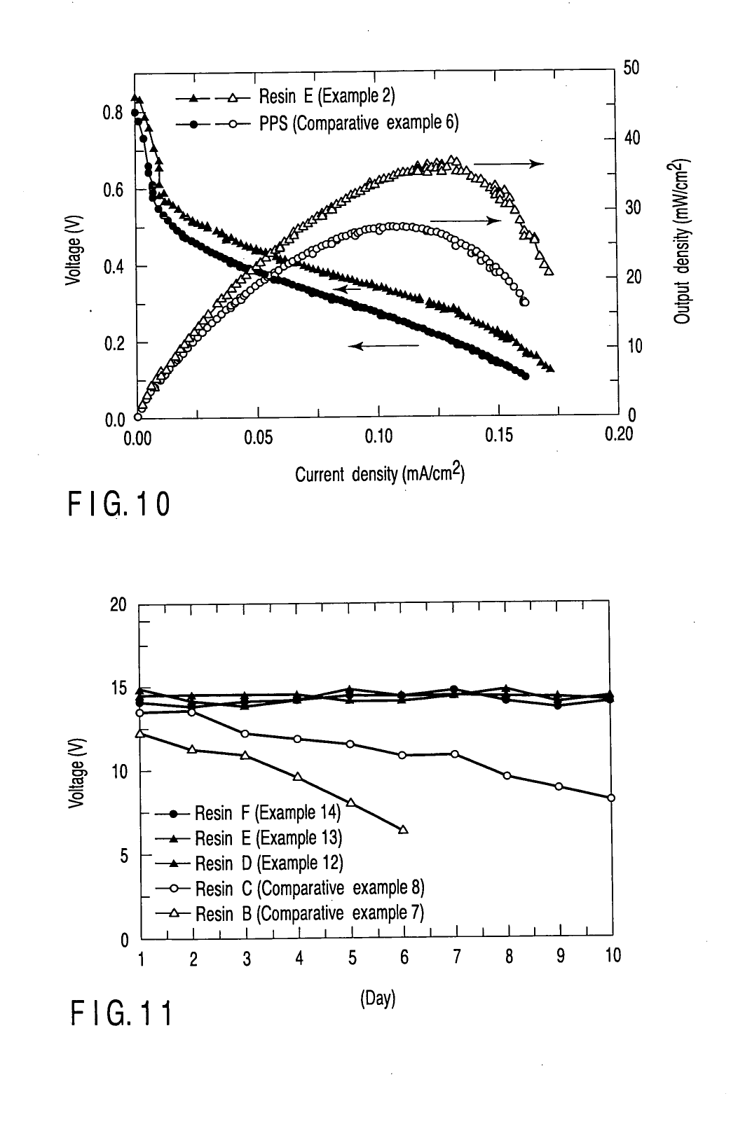

The separators were fixed to the MEA by using SUS end plate and screws. As the sealing member, a fluoroplastic sheet was used. In the anode passage, 2M aqueous methanol solution was supplied at a flow rate of 1 mL/min by using a commercial liquid feed pump. In the cathode passage, air was supplied at a flow rate of 3 L/min by using a commercial air pump. The air flow rate was adjusted by using a commercial mass flow controller. As the load, a commercial electronic load machine was used. Using a commercial temperature controller and a heater, the temperature of unit cell was controlled. As voltage detecting means, a commercial digital multimeter was used. Controlling the unit cell temperature at 60° C., the performance was evaluated. Example 2 (resin E) and Comparative example 6 (PPS) were compared in experiment, and results are shown in a graph in FIG. 10.

The fuel cell in Example 2 (resin E) was almost uniform and high in voltage over a wide current density region as compared with the fuel cell in Comparative example 6 (PPS). This is because the separator made of resin E is higher in bending strength than the separator made of PPS, and hence the separator is tightened favorably, and air does not leak but is sufficiently fed into the cathode and the overvoltage in the cathode is lowered, so that the voltage is raised.

Table 4 summarizes results of other materials. Example 1 (resin D) and Example 2 (resin E) having the separator of which bending strength is over 10 GPa are higher in output as compared with Comparative examples 1 to 6.

TABLE 4
(Anode separator, cathode separator)

| | Separator | | | | | Electric | |
|---|---|---|---|---|---|---|---|
| | | | Glass | Coefficient | Bending | conductive | |
| | | Electric | transition | of thermal | modulus of | portion of | Maximum |
| | Type of | conductive | temperature | expansion | elasticity | sealing | output |
| | resin | portion | (° C.) | (×10⁻⁵/° C.) | (GPa) | member | (mW/cm²) |
| Comparative | Resin A | Gold foil | 175 | 6.4 | 6 | Gold foil | 35 |
| example 1 | | | | | | | |
| Comparative | Resin B | Gold foil | 174 | 4.4 | 10 | Gold foil | 40 |
| example 2 | | | | | | | |
| Example 1 | Resin D | Gold foil | 174 | 4 | 15 | Gold foil | 47 |
| Example 2 | Resin E | Gold foil | 174 | 3.2 | 16 | Gold foil | 47 |
| Comparative | Resin PEEK | Gold foil | 140 | 4.7 | 3.6 | Gold foil | 27 |
| example 3 | | | | | | | |
| Comparative | Resin PEI | Gold foil | 240 | 5.6 | 3.3 | Gold foil | 26 |
| example 4 | | | | | | | |
| Comparative | Resin PES | Gold foil | 225 | 5.6 | 2.6 | Gold foil | 25 |
| example 5 | | | | | | | |
| Comparative | Resin PPS | Gold foil | 90 | 4.0 | 3.9 | Gold foil | 26 |
| example 6 | | | | | | | |

### EXAMPLES 3 TO 11

From the resin tablets shown in Tables 1 and 2, F, J, K, L, M, N, O, P and Q were selected, and separators 13 and 17 having the structure as shown in FIGS. 4A, 4B, 4C, 5A, 5B, and 5C were prepared. Carbon was used in the electric conductive portions of the separators. The thickness of the separator was 3 mm, and the thickness of the electric conductive portion was 0.3 mm. Volume resistivity was 1000 μΩcm. The glass transition temperature, coefficient of linear expansion and bending modulus of elasticity of the separators are shown in Table 5.

These separators 13 and 17 were combined together with 32 MEA with an electrode area of 9 cm² (3 cm×3 cm), and the sealing member 9 having the structure as shown in FIG. 3 and end plate 21, and a stack as shown in FIG. 1 was fabricated. As the sealing member 9, a commercial polytetrafluoroethylene resin sheet was used. Gold was used for the conductor wires 11 and electric conductive portions 12 of the sealing member 9. Volume resistivity of gold was 2 μΩcm. On the other hand, the end plate 21 was made of resin F, the glass transition temperature was 174° C., the coefficient of linear expansion was 2.7×10⁻⁵/° C., and the bending modulus of elasticity was 17 GPa.

In the anode passage of this stack, 3M aqueous methanol solution was supplied at a flow rate of 18 mL/min. In the cathode passage, air was supplied at a flow rate of 6 L/min. The temperature of the stack was controlled at 60° C. Results of measuring maximum output are shown in Table 5. A favorable output is obtained regardless of combination. In particular, in Example 3 using the separator including resin F containing epoxy resin and silica, the maximum output of the fuel cell was high.

TABLE 5
(Anode separator, cathode separator)

| | Separator | | | | | Electric | |
|---|---|---|---|---|---|---|---|
| | | | Glass | Coefficient | Bending | conductive | |
| | | Electric | transition | of thermal | modulus of | portion of | Maximum |
| | Type of | conductive | temperature | expansion | elasticity | sealing | output |
| | resin | portion | (° C.) | (×10⁻⁵/° C.) | (GPa) | member | (mW/cm²) |
| Example 3 | Resin F | Carbon region | 174 | 2.7 | 17 | Au region | 43 |
| Example 4 | Resin J | Carbon region | 175 | 2.6 | 15 | Au region | 38 |
| Example 5 | Resin K | Carbon region | 175 | 2.3 | 15 | Au region | 38 |
| Example 6 | Resin L | Carbon region | 175 | 2.2 | 15 | Au region | 38 |
| Example 7 | Resin M | Carbon region | 201 | 2 | 12 | Au region | 40 |
| Example 8 | Resin N | Carbon region | 143 | 2.5 | 12 | Au region | 39 |
| Example 9 | Resin O | Carbon region | 110 | 2.7 | 11 | Au region | 39 |
| Example 10 | Resin P | Carbon region | 174 | 2.3 | 11 | Au region | 38 |
| Example 11 | Resin Q | Carbon region | −50 | 2.2 | 12 | Au region | 38 |

### EXAMPLES 12 TO 14 AND COMPARATIVE EXAMPLES 7 AND 8

Using B, C, D, E, and F from the resin tablet shown in Table 1, separators having the structure as shown in FIGS. 4A, 4B, 4C, 5A, 5B, and 5C were prepared. Carbon was used in the electric conductive portions of the separators. The thickness of the separator was 3 mm, and the thickness of the electric conductive portion was 0.3 mm. The volume resistivity was 1000 μΩcm. The glass transition temperature, coefficient of linear expansion at 20° C. and bending modulus of elasticity at 20° C. of the separators are shown in Table 6.

This separator was combined together with 32 MEA with an electrode area of 9 cm² (3 cm×3 cm), and the sealing member 9 shown in FIG. 3 and end plate 21 having coefficient of linear expansion at 20° C. of 1.0×10⁻⁵/° C. and bending strength at 20° C. of 20 GPa, and a stack as shown in FIG. 1 was fabricated.

As the sealing member, a commercial polytetrafluoroethylene resin sheet was used. Gold was used for the conductor wires and electric conductive portions of the sealing member. The volume resistivity of gold was 2 μΩcm.

In the anode passage of this stack, 1M aqueous methanol solution was supplied at a flow rate of 18 mL/min. In the cathode passage, air was supplied at a flow rate of 6 L/min. The temperature of the stack was controlled at 60° C., and the load current of 100 mA/cm² was applied for 8 hours a day. In the remaining 16 hours, supply of fuel and feed of air were stopped, leaving at room temperature. This operation was repeated for 10 days, and time-course changes of voltage per unit cell were investigated. FIG. 11 is a diagram of plotting of voltage in 8 hours every day. In the stacks of Examples 12 to 14 using resins D, E and F as the separator, the voltage was almost constant throughout 10 days. By contrast, in the stack of Comparative example 8 using resin C as the separator, the voltage declined. In the stack of Comparative example 7 using resin B as the separator, the voltage drop was too large, and no voltage was obtained after 7 days. This is because the stack temperature changed up and down repeatedly between 60° C. and room temperature, whereby the separator repeated expansion and contraction, the fuel leaked in this process, and the MEA was damaged. In particular, when the aqueous methanol solution leaks and the aqueous methanol solution gets into the proton conductive electrolyte contained in the cathode, the MEA is seriously damaged.

TABLE 6
(Anode separator, cathode separator)

| | Separator | | | | | Electric |
|---|---|---|---|---|---|---|
| | | | Glass | Coefficient | Bending | conductive |
| | | Electric | transition | of thermal | modulus of | portion of |
| | Type of | conductive | temperature | expansion | elasticity | sealing |
| | resin | portion | (° C.) | (×10⁻⁵/° C.) | (GPa) | member |
| Comparative | Resin B | Carbon region | 174 | 4.4 | 10 | Au region |
| Example 7 | | | | | | |
| Comparative | Resin C | Carbon region | 174 | 4.2 | 13 | Au region |
| Example 8 | | | | | | |
| Example 12 | Resin D | Carbon region | 174 | 4 | 15 | Au region |
| Example 13 | Resin E | Carbon region | 174 | 3.2 | 16 | Au region |
| Example 14 | Resin F | Carbon region | 174 | 2.7 | 17 | Au region |

### EXAMPLES 15 TO 20 AND COMPARATIVE EXAMPLES 9 AND 10

Using resin tablets B to I shown in Tables 1 and 2, separators 13 and 17 having the structure as shown in FIGS. 4A, 4B, 4C, 5A, 5B, and 5C were prepared. Carbon was used in the electric conductive portions of the separators. The thickness of the separator was 3 mm, and the thickness of the electric conductive portion was 0.3 mm. The volume resistivity was 1000 μΩcm. The glass transition temperature, coefficient of linear expansion at 20° C. and bending modulus of elasticity at 20° C. of separators are shown in Table 7.

The separators 13 and 17 were combined together with 32 MEA with an electrode area of 9 cm² (3 cm×3 cm), and the sealing member 9 shown in FIG. 3 and end plate 21, and stacks as shown in FIG. 1 were fabricated. As the sealing member, a commercial polytetrafluoroethylene resin sheet was used. Gold was used for the conductor wires 11 and electric conductive portions 12 of the sealing member 11. The volume resistivity of gold was 2 μΩcm. On the other hand, the end plate 21 was made of resin F, the glass transition temperature was 174° C., the coefficient of linear expansion at 20° C. was 2.7×10⁻⁵/° C., and the bending modulus of elasticity at 20° C. was 17 GPa.

In the anode passage of this stack, 1M aqueous methanol solution was supplied at a flow rate of 25 mL/min. In the cathode passage, air was supplied at a flow rate of 7 L/min. The temperature of the stack was controlled at 60° C., and the performance was evaluated. Maximum output is shown in Table 7. In fuel cells of Examples 15 to 20 using separators containing resins D to I, a high output of over 60 mW/cm² was obtained. Hence, as in the material composition of resins D to I, preferably, the content of the thermosetting resin should be 1 wt. % or more and 47 wt. % or less, and the content of the inorganic filler should be 50 wt. % or more and 96 wt. % or less.

TABLE 7
(Anode separator, cathode separator)

| | Separator | | | | | Electric | |
|---|---|---|---|---|---|---|---|
| | | | Glass | Coefficient | Bending | conductive | |
| | | Electric | transition | of thermal | modulus of | portion of | Maximum |
| | Type of | conductive | temperature | expansion | elasticity | sealing | output |
| | resin | portion | (° C.) | (×10⁻⁵/° C.) | (GPa) | member | (mW/cm²) |
| Comparative | Resin B | Carbon region | 174 | 4.4 | 10 | Au region | 45 |
| example 9 | | | | | | | |
| Comparative | Resin C | Carbon region | 174 | 4.2 | 13 | Au region | 50 |
| example 10 | | | | | | | |
| Example 15 | Resin D | Carbon region | 174 | 4 | 15 | Au region | 60 |
| Example 16 | Resin E | Carbon region | 174 | 3.2 | 16 | Au region | 61 |
| Example 17 | Resin F | Carbon region | 174 | 2.7 | 17 | Au region | 62 |
| Example 18 | Resin G | Carbon region | 175 | 2.1 | 18 | Au region | 61 |
| Example 19 | Resin H | Carbon region | 174 | 1.6 | 19 | Au region | 60 |
| Example 20 | Resin I | Carbon region | 174 | 1.3 | 20 | Au region | 60 |

### EXAMPLES 21 TO 24

Using resin tablet F shown in Tables 1 and 2, the separator 13 having the structure as shown in FIGS. 4A, 4B, and 4C, and the separator 17 having the structure as shown in FIGS. 5A, 5B, and 5C were prepared. The sealing member 9 was made of a commercial polytetrafluoroethylene resin sheet. The electric conductive portions 15 and 19 of the separators 13 and 17, and conductor wires 11 and electric conductive portions 12 of the sealing member 9 were formed of four types of substances different in volume resistivity. The four types are commercial gold (Example 21), carbon (Example 22), mixture of carbon and phenol resin (Example 23), and mixture of carbon and epoxy resin (Example 24). The volume resistivity of each electric conductive portion is shown in Table 8.

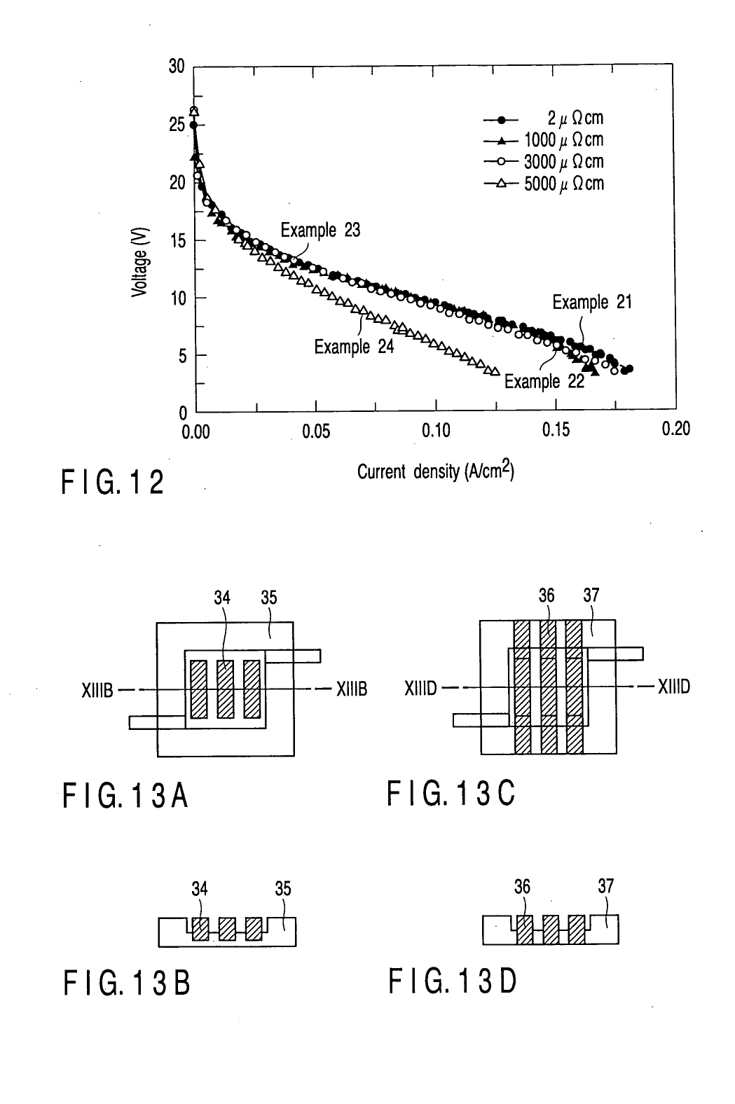

Using these separators and sealing member, stacks having the structure as shown in FIG. 1 were assembled, and the stack temperature was controlled at 60° C., and 2M aqueous methanol solution was supplied at a flow rate of 18 mL/min in the anode passage. In the cathode passage, air was supplied at a flow rate of 1 L/min. At this time, the dependence of voltage on the load current density is shown in FIG. 12. In the stack of Example 24 using a mixture of carbon and epoxy resin, the voltage drop rate is larger than in Examples 21 to 23. Hence, the upper limit of the volume resistivity of electric conductive substance is preferred to be 3000 μΩcm.

TABLE 8
(Anode separator, cathode separator)

| | | | | | | Volume resistivity |
|---|---|---|---|---|---|---|
| | Separator | | | | Type of electric | of electric |
| | | Glass | Coefficient | Bending | conductive | conductive portion |
| | | transition | of thermal | modulus of | portion of | of separator and |
| | Type of | temperature | expansion | elasticity | separator and | sealing member |
| | resin | (° C.) | (×10⁻⁵/° C.) | (GPa) | sealing member | (μ Ω cm) |
| Example 21 | Resin F | 174 | 2.7 | 17 | Au region | 2 |
| Example 22 | Resin F | 174 | 2.7 | 17 | Carbon region | 1000 |
| Example 23 | Resin F | 174 | 2.7 | 17 | Carbon + phenol | 3000 |
| | | | | | resin region | |
| Example 24 | Resin F | 174 | 2.7 | 17 | Carbon + epoxy | 5000 |
| | | | | | resin region | |

### EXAMPLES 25 TO 31 AND COMPARATIVE EXAMPLES 11 TO 14

Using A, B, C, D, E, F, G, Q, R, S and T out of resin tablets shown in Table 1, end plates were prepared. The glass transition temperature, coefficient of linear expansion at 20° C. and bending modulus of elasticity at 20° C. of each end plate are shown in Table 9. Stacks as shown in FIG. 8 were fabricated by using these end plates, separators for cathode having the structure shown in FIGS. 4A to 4C, separators for anode having the structure shown in FIGS. 5A to 5C, 32 MEA with an electrode area of 9 cm² (3 cm×3 cm), and sealing member having the structure shown in FIG. 3.

The material of the separators was resin F. Carbon was used for electric conductive portions of the separator. The volume resistivity of carbon was 1000 μΩcm. In the separator for cathode and separator for anode, the glass transition temperature was 174° C., the coefficient of linear expansion at 20° C. was 2.7×10⁻⁵/° C., and the bending modulus of elasticity at 20° C. was 17 GPa.

As the sealing member, a commercial polytetrafluoroethylene resin sheet was used. Gold was used for the conductor wires and electric conductive portions of the sealing member. The volume resistivity of gold was 2 μΩcm.

In the anode passage of this stack, 2M aqueous methanol solution was supplied at a flow rate of 18 mL/min. In the cathode passage, air was supplied at a flow rate of 6 L/min. The temperature of the stack was controlled at 60° C., and the performance was evaluated.

TABLE 9
(End Plate)

| | End plate | | | | | Electric | |
|---|---|---|---|---|---|---|---|
| | | Glass | Coefficient | Bending | Electric | conductive | |
| | | transition | of thermal | modulus of | conductive | portion of | Fuel leak |
| | Type of | temperature | expansion | elasticity | portion of | sealing | in power |
| | resin | (° C.) | (×10⁻⁵/° C.) | (GPa) | separator | member | generation |
| Comparative | Resin A | 175 | 6.4 | 6 | Carbon region | Au region | Fuel leak |
| example 11 | | | | | | | |
| Comparative | Resin B | 174 | 4.4 | 10 | Carbon region | Au region | Fuel leak |
| example 12 | | | | | | | |
| Comparative | Resin C | 174 | 4.2 | 13 | Carbon region | Au region | Fuel leak |
| example 13 | | | | | | | |
| Example 25 | Resin D | 174 | 4 | 15 | Carbon region | Au region | Not leak |
| Example 26 | Resin E | 174 | 3.2 | 16 | Carbon region | Au region | Not leak |
| Example 27 | Resin F | 174 | 2.7 | 17 | Carbon region | Au region | Not leak |
| Example 28 | Resin G | 175 | 2.1 | 18 | Carbon region | Au region | Not leak |
| Example 29 | Resin Q | −50 | 2.2 | 12 | Carbon region | Au region | Not leak |
| Example 30 | Resin R | −50 | 2.5 | 10 | Carbon region | Au region | Not leak |
| Example 31 | Resin S | −50 | 2.8 | 5 | Carbon region | Au region | Not leak |
| Comparative | Resin T | −50 | 3.3 | 3 | Carbon region | Au region | Fuel leak |
| example 14 | | | | | | | |

In the stacks of Comparative examples 11 to 14 using resins A, B, C and T in the end plates, fuel leaked significantly, and the performance could not be evaluated. Hence, the upper limit of the coefficient of linear expansion at 20° C. of the material of end plate was set at 4×10⁻⁵/° C., and the lower limit of the bending strength at 20° C. was set at 5 GPa.

In the stack of Example 27 using the end plate made of resin F, the dependence of fuel cell performance on temperature was studied. As a result, a high performance was obtained at 100° C. When the performance was observed for a month, almost same performance was maintained.

### EXAMPLE 32 AND COMPARATIVE EXAMPLE 15

A separator 35 (Example 32) was fabricated by insert molding method. As shown in FIG. 13A, the electric conductive portions 34 were inserted in the recess of the surface of the separator 35. The lower end of each electric conductive portion 34 was embedded in the inner surface of the recess. The upper end of each electric conductive portion 34 protruded from the inner surface of the recess. The electric conductive portions 34 functioned as a wall of an anode passage or a wall of a cathode passage. And, a separator 37 (comparative example 15) was fabricated by using electric conductive portions 36 penetrating in the thickness direction as shown in FIG. 13C. The electric conductive portions 36 functioned as an anode passage wall or a cathode passage wall. The main body of the separators 35 and 37 was made of resin E. Carbon was used for the electric conductive portions 34 and 36. The electrode area was 25 cm² (5 cm×5 cm). The bending modulus of elasticity of separator in Example 32 was 16 GPa, but the bending modulus of elasticity of the separator in Comparative example 15 was 1 GPa, and was significantly lowered. The performance was evaluated in these samples. In the anode, 1M aqueous methanol solution was supplied at a flow rate of 2 mL/min, and in the cathode, air was supplied at a flow rate of 500 mL/min. When the separator of Example 32 was used in both the anode separator and cathode separator, an output of 40 mW/cm² was obtained. On the other hand, when the separator of Comparative example 15 was used in both the anode separator and cathode separator, an output of only 5 mW/cm² was obtained. This is because the resin region is cut off by the electric conductive portions in Comparative example 15, and the bending strength of the resin is lowered.

### EXAMPLES 33 TO 45

Using materials of resin tablet F shown in Tables 1 and 2, separator 13 having the structure as shown in FIGS. 4A, 4B, and 4C, and separator 17 having the structure as shown in FIGS. 5A, 5B, and 5C were prepared.

No surface treatment was applied in the obtained separators 13 and 17 in Example 33. The surface of the separators 13, 17 was polished by sand paper A of surface roughness of No. 50 in Example 34. The surface of the separators 13, 17 was polished by sand paper B of surface roughness of No. 200 in Example 35. The surface of the separators 13, 17 was polished by sand paper C of surface roughness of No. 1,000 in Example 36.

On the other hand, the surface of the separators 13, 17 was applied to an abrasive blasting with glass beads A of particle size distribution of 350 μm to 500 μm in Example 37. The surface of the separators 13, 17 was applied to an abrasive blasting with glass beads B of particle size distribution of 177 μm to 250 μm in Example 38. The surface of the separators 13, 17 was applied to an abrasive blasting with glass beads C of particle size distribution of 105 μm to 125 μm in Example 39.

The surface of the separators 13, 17 was treated with plasma by DP system in Ar gas for 1 minute in Example 40. The plasma treatment time was 3 minutes in Example 41, and 5 minutes in Example 42.

The surface of the separators 13, 17 was treated with plasma by RIE system in O₂ gas for 1 minute in Example 43. The plasma treatment time was 3 minutes in Example 44, and 5 minutes in Example 45.

Carbon was used for electric conductive portions of the separators in Examples 33 to 45. The volume resistivity of electric conductive portions was 1000 μΩcm.

The contact angle of separators in Examples 33 to 45 was measured by liquid drop method. That is, test pieces were prepared according to the method specified in JIS class 1 in JIS K 7100, a water drop was applied on the test piece surface, and 1 second later, the contact angle was measured by a contact angle measuring instrument (model CA-Z of Kyowa Kaimen Kagaku Co.). Results are shown in Table 10.

TABLE 10

| | | Contact |
|---|---|---|
| | | angle |
| | Treating method | (degree) |
| Example 33 | Not treated | 80 |
| Example 34 | Sand paper A | 50 |
| Example 35 | Sand paper B | 35 |
| Example 36 | Sand paper C | 10 |
| Example 37 | Glass beads A | 30 |
| Example 38 | Glass beads B | 30 |
| Example 39 | Glass beads C | 20 |
| Example 40 | DP plasma treatment A (1 min) | 50 |
| Example 41 | DP plasma treatment B (3 min) | 35 |
| Example 42 | DP plasma treatment C (5 min) | 10 |
| Example 43 | RIE plasma treatment A (1 min) | 40 |
| Example 44 | RIE plasma treatment B (3 min) | 30 |
| Example 45 | RIE plasma treatment C (5 min) | 10 |

As in clear from Table 10, in the untreated separator in Example 33, the contact angle was high at 80 degrees, but the contact angle decreased as the surface of the separator was treated.

Combining the separators 13, 17 in Examples 33 to 45, and the sealing member 9 having the structure shown in FIG. 3 and the end plate 21, stacks having the structure shown in FIG. 1 were fabricated. As the sealing member 9, a commercial polytetrafluoroethylene resin sheet was used. Gold was used for the conductor wires 11 and electric conductive portions 12 of the sealing member 9. The volume resistivity of gold was 2 μΩcm. The end plate 21 was made of resin F. The glass transition temperature, coefficient of linear expansion, and bending modulus of elasticity of the end plate 21 were same as in Example 27.

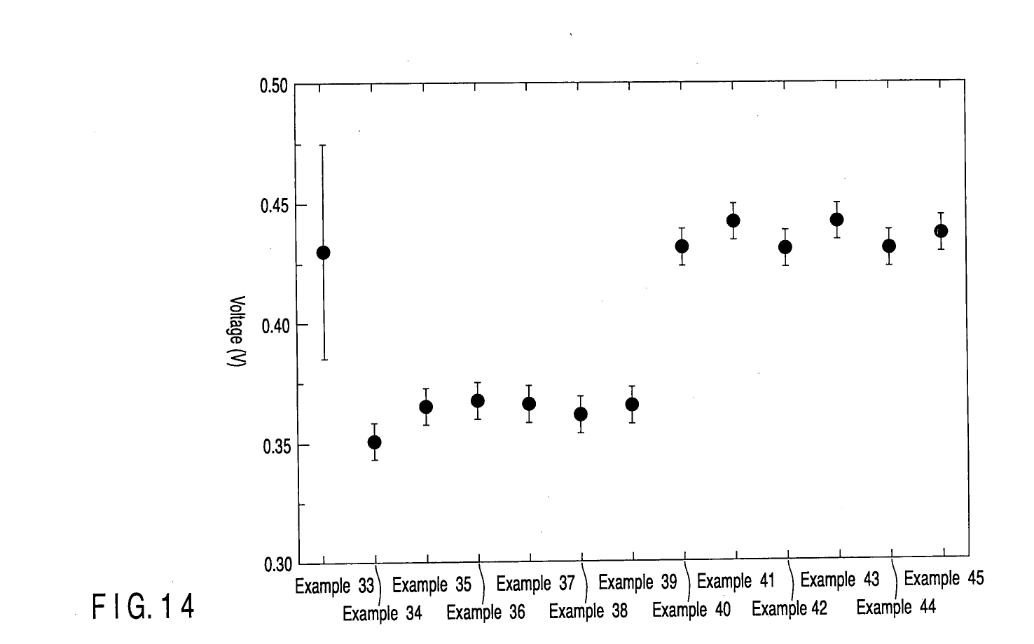

In the anode passage of this stack, 1M aqueous methanol solution was supplied at a flow rate of 25 mL/min. In the cathode passage, air was supplied at a flow rate of 1 L/min. The temperature of the stack was controlled at 80° C., and by continuous operation for 48 hours at load current of 150 mA/cm², the average voltage per unit cell was investigated. Results are shown in FIG. 14.

As in clear from FIG. 14, in the fuel cell of Example 33 having the separator of which surface was not treated, voltage fluctuations in 48 hours varied widely from 0.38 to 0.475 V. It shows the flow of liquid fuel and produced water was not sufficiently smooth.

In the fuel cells of Examples 34 to 36 having the separators of which surface was polished by sand paper, and in the fuel cells of Examples 37 to 39 having the separators of which surface was applied to the abrasive blasting with glass beads, voltage fluctuation margin was narrow and voltage stability was high, but average voltage was lower than in Example 33. It shows the separator surface was damaged heavily to cause fuel leak and voltage drop.

In the fuel cells of Examples 40 to 45 having the separators of which surface was treated with plasma, the average voltage was same as or larger than in Example 33, and the voltage stability was high. It shows the flow of liquid fuel and produced water was sufficiently smooth, without fuel leak. Hence, plasma treatment is preferred.

Thus, one embodiment of the invention provides an insulating separator for liquid fuel cell, an insulating end plate for liquid fuel cell, and a liquid fuel cell using them having a high strength and capable of withstanding tightening. Besides, since the volume resistivity is sufficiently low, MEA arranged in a flat plane can be insulated easily. Being low in reactivity with fuel or product, and high in resistance to corrosion, one embodiment of the invention is suited to the liquid fuel cell. It can be preferably applied in a fuel cell using gas fuel.

As MEA of fuel cells, other known structures and materials may be used aside from those shown in the examples. For example, as the proton conductive electrolyte membrane, aside from a perfluorocarbon sulfonic acid membrane, all other known materials such as carbon derivative membranes can be used. In the examples, perfluorocarbon sulfonic acid solution is mixed in the anode and cathode, but other known proton conductive materials can be preferably used. As the catalyst, Pt, two-element catalysts represented by Pt—Ru, Pt—Sn, and Pt—Fe, three-element catalysts such as Pt—Ru—Sn, four-element catalysts such as Pt—Ru—Ir—Os, and all other known materials can be used in both anode and cathode. The catalyst can be used in either carried state or non-carried state.

As described herein, one embodiment of the invention provides a separator for fuel cell and end plate for fuel cell which are not curved, warped, flexed or deformed when tightened by tightening screws, and a fuel cell power generation apparatus comprising such a separator for fuel cell or end plate for fuel cell.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. A fuel cell power generation apparatus comprising:
a stack section including an anode, a cathode, an electrolyte layer provided between the anode and the cathode, and a separator including at least one of an anode passage which supplies liquid fuel to the anode and a cathode passage which supplies oxidizer to the cathode; and
an end plate provided on the outermost layer of the stack section,
wherein the separator contains an inorganic filler and a thermosetting resin, and has glass transition temperature of 20° C. or less and 100° C. or more, coefficient of thermal expansion at 20° C. of 0.4×10⁻⁵/° C. or more and 4×10⁻⁵/° C. or less, and bending modulus of elasticity at 20° C. of 5 GPa or more and 30 GPa or less.

2. The fuel cell power generation apparatus according to claim 1, wherein the separator includes electric conductive portions in a surface thereof.

3. The fuel cell power generation apparatus according to claim 2, wherein a volume resistivity of the electric conductive portions is in a range of 0.1 μΩcm to 3000 μΩcm.

4. The fuel cell power generation apparatus according to claim 1, wherein a content of the thermosetting resin in the separator is 1 wt. % or more and 47 wt. % or less.

5. The fuel cell power generation apparatus according to claim 1, wherein a content of the inorganic filler in the separator is 50 wt. % or more and 96 wt. % or less.

6. The fuel cell power generation apparatus according to claim 1, wherein the thermosetting resin is at least one resin selected from the group consisting of epoxy resin, maleimide resin, phenol resin, polyester resin, diallyl phthalate resin, and silicone resin.

7. The fuel cell power generation apparatus according to claim 1, wherein the thermosetting resin is epoxy resin, and the inorganic filler is silicon oxide powder.

8. The fuel cell power generation apparatus according to claim 1, wherein the glass transition temperature is in a range of −100° C. to 20° C. or in a range of 100° C. to 250° C., the coefficient of thermal expansion at 20° C. is 0.4×10⁻⁵/° C. or more and 1.5×10⁻⁵/° C. or less, and the bending modulus of elasticity at 20° C. is 10 GPa or more and 30 GPa or less.

9. The fuel cell power generation apparatus according to claim 1, wherein a contact angle of the separator is 0 to 50 degrees.

10. The fuel cell power generation apparatus according to claim 9, wherein the separator has its surface treated by plasma.

11. The fuel cell power generation apparatus according to claim 1, wherein the end plate contains an inorganic filler and a thermosetting resin, and has glass transition temperature of 20° C. or less and 100° C. or more, coefficient of thermal expansion at 20° C. of 0.4×10⁻⁵/° C. or more and 4×10⁻⁵/° C. or less, and bending modulus of elasticity at 20° C. of 5 GPa or more and 30 GPa or less.

12. The fuel cell power generation apparatus according to claim 1, wherein the stack section further comprises a sealing member containing an electric conductive substance.

13. A fuel cell power generation apparatus comprising:
a stack section including an anode, a cathode, an electrolyte layer provided between the anode and the cathode, and a separator including at least one of an anode passage which supplies liquid fuel to the anode and a cathode passage which supplies oxidizer to the cathode; and
an end plate provided on the outermost layer of the stack section,
wherein the end plate contains an inorganic filler and a thermosetting resin, and has glass transition temperature of 20° C. or less and 100° C. or more, coefficient of thermal expansion at 20° C. of 0.4×10⁻⁵/° C. or more and 4×10⁻⁵/° C. or less, and bending modulus of elasticity at 20° C. of 5 GPa or more and 30 GPa or less.

14. The fuel cell power generation apparatus according to claim 13, wherein a content of the thermosetting resin in the end plate is 1 wt. % or more and 47 wt. % or less.

15. The fuel cell power generation apparatus according to claim 13, wherein a content of the inorganic filler in the end plate is 50 wt. % or more and 96 wt. % or less.

16. The fuel cell power generation apparatus according to claim 13, wherein the thermosetting resin is epoxy resin, and the inorganic filler is silicon oxide powder.

17. The fuel cell power generation apparatus according to claim 13, wherein a contact angle of the end plate is 0 to 50 degrees.

18. The fuel cell power generation apparatus according to claim 17, wherein the end plate has its surface treated by plasma.

19. A separator for fuel cell, containing an inorganic filler and a thermosetting resin, and having glass transition temperature of 20° C. or less and 100° C. or more, coefficient of thermal expansion at 20° C. of 0.4×10⁻⁵/° C. or more and 4×10⁻⁵/° C. or less, and bending modulus of elasticity at 20° C. of 5 GPa or more and 30 GPa or less.

20. An end plate for fuel cell, containing an inorganic filler and a thermosetting resin, and having glass transition temperature of 20° C. or less and 100° C. or more, coefficient of thermal expansion at 20° C. of 0.4×10⁻⁵/° C. or more and 4×10⁻⁵/° C. or less, and bending modulus of elasticity at 20° C. of 5 GPa or more and 30 GPa or less.
